(19) United States
(12) Patent Application Publication
(10) Pub. No.: US 2005/0212662 A1
(43) Pub. Date: Sep. 29, 2005

(54) Method of securing a deactivation of a rfid transponder

(75) Inventors: Franz Amtmann, Graz (AT); Josef Preishuber-Pflugl, Graz (AT); Michael Cernusca, Judendorf-Strassengel (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V. GROENEWOUDSEWEG 1, 5621 BA EINDHOVEN (NL)

(21) Appl. No.: 10/513,124

(22) PCT Filed: Apr. 9, 2003
(86) PCT No.: PCT/IB03/01434

§ 371 Date: Oct. 28, 2004

(30) Foreign Application Priority Data
Apr. 30, 2002 (EP) 02100435.3

(51) Int. Cl. G08B 13/14

(52) U.S. Cl. 340/10.51; 340/572.3

(57) ABSTRACT

A transponder (10) which is combined with a product and contains a product code which is significant for the product can be set to a first safety state when the product undergoes a transfer from a first product location area to a second product location area, via a safety state activation zone which includes a communication station, and can be set to a second safety state if the transponder has been set to the first safety state. A transponder (10) set to the second safety state can be permanently deactivated.

The invention relates to a method of securing a transponder against undesirable manipulation, which transponder is combined with a product, contains a product code which is significant for the product, and is constructed for wireless communication with a communication station.

The invention also relates to a transponder which is intended to be combined with a product, is constructed for wireless communication with a communication station, and includes storage means for storing a product code which is significant for the product.

The invention also relates to an integrated circuit which is constructed for a transponder which is intended to be combined with a product and is constructed for wireless communication with a communication station, said integrated circuit comprising storage means for storing a product code which is significant for the product.

In the context of a method of the kind set forth and a transponder of the kind set forth as well as an integrated circuit of the kind set forth, the applicant knows a method of securing in which the product code can be read from the storage means. Unauthorized reading of the significant product code is, of course, undesirable; therefore, there is a possibility for preventing such reading. In this respect a deactivation or inhibition of reading can be realized by means of a communication station for communication with the transponder. Such deactivation is protected by means of a password or a cryptographic code so as to avoid abuse. This method of securing involves a causal relationship between the password and the significant product code so that the password must be transferred to a customer or purchaser or owner of the product. The use of such a password involves the risk of the password being “cracked”, so that it can be used without authorization; notably in this case such cracking is favored by making the relevant password known to a wide public, thus having very adverse effects. The safety of the use of such a password can be enhanced by way of the complexity of an algorithm used for generating such a password. However, the complexity of the means used for carrying out the algorithm then increases to the same extent, implying inter alia a larger amount of calculation work when the means concern, for example, a microcomputer in the transponder or the integrated circuit for the transponder. The more severe requirements ultimately lead to an increased need for surface area and/or degree of integration of the integrated circuit for the transponder; this necessitates more effort and higher costs, so that it is disadvantageous.

It is an object of the invention to eliminate the described drawbacks and to realize an improved method and an improved transponder and an improved integrated circuit.

In order to achieve said object, a method in accordance with the invention is provided with features in accordance with the invention such that a method in accordance with the invention can be characterized as follows:
a method of securing a transponder against undesirable manipulation, which transponder is combined with a product, contains a product code which is significant for the product, and is constructed for wireless communication with a communication station, in which method at least one change of state is carried out, the transponder being set, during a first step of the method involving a first change of state, from an initial state to a first safety state when the product undergoes a transfer from a first product location area to a second product location area, via a safety state activation zone which includes a communication station, and in which method, if the transponder has been set to the first safety state due to the transfer, the transponder is set to a second safety state, if desired, during a second step of the method in which a second change of state is carried out.

In order to achieve said object, a transponder in accordance with the invention is provided with features such that a transponder in accordance with the invention can be characterized as follows:
a transponder which is intended to be combined with a product, is constructed for wireless communication with a communication station, includes storage means for storing a product code which is significant for the product, is constructed for carrying out at least one change of state, and includes first state changing means by means of which the transponder can be set from an initial state to a first safety state if the product with which the transponder is combined is transferred from a first product location area to a second product location area, via a safety state activation zone which includes a communication station, and also includes second state changing means by means of which the transponder can be set to a second safety state if the transponder has been set to the first safety state.

In order to achieve the above object, an integrated circuit in accordance with the invention is provided with features in accordance with the invention such that an integrated circuit in accordance with the invention can be characterized as follows.
an integrated circuit for a transponder which is intended to be combined with a product and is constructed for wireless communication with a communication station, which integrated circuit includes storage means for storing a product code which is significant for the product and for carrying out at least one change of state, and includes first state changing means by means of which the integrated circuit can be set from an initial state to a first safety state if the product with which the transponder is combined is transferred from a first product location area to a second product location area, via a safety state activation zone which includes a communication station, and also includes second state changing means by means of which the integrated circuit can be set to a second safety state if the integrated circuit has been set to the first safety state.

By providing the features in accordance with the invention, it is achieved, in a simple manner and using simple means, that it is more difficult to carry out abusive so-called “killing” or “destruction” of a transponder, that is, permanent deactivation of the reading of the product code from a transponder. In this case this is achieved in that the transponder is set, by way of a change of state, from an initial state to a first safety state and that such a change of state can take place in a secured environment. In this context a secured environment is to be understood to mean that only a limited number of persons is authorized to carry out the change of state from the initial state to the first safety state, it being possible for the execution of this state of change to be protected by means of a password or a cryptographic key and to be carried out in a secured environment. Such a secured environment may be defined, for example, by a point of sales (POS) terminal, that is a sales terminal or a cash register where a user or a customer can purchase or pay for a product which is combined with a transponder which has a product code which is significant for the product. The safety state activation zone is defined by means of this point of sales (POS) terminal. When the transponder has been set to the first safety state by moving past this terminal, and hence by transfer through the safety state activation zone, the customer can set the transponder to a second safety state in which the reading of the product code by unauthorized persons is prevented.

For the solutions in accordance with the invention it has been found that it is particularly advantageous when additionally the features in conformity with claim 2 and claim 9 and claim 13, respectively, are provided. Recourse can thus be taken to already existing possibilities for communication and interaction.

For a method in accordance with the invention it has been found that it is particularly advantageous when the first step of the method is carried out at a so-called point of sales (POS) terminal. Preferably, in this case a sale or payment of the product and the setting of the transponder to a first safety state take place at a single station only.

For a method in accordance with the invention it has also been found that it is particularly advantageous if, when the first change of state is carried out so that the transponder is set to a first safety state, a write protection for storage sections of the transponder is deactivated and the transponder, if desired, is set from the first safety state to a second safety state, in which second safety state the write protection for storage sections of the transponder is activated. As a result, a product which is undetachably combined with a transponder can thus be used further.

For the solutions in accordance with the invention it has also been found that it is particularly advantageous to provide additionally the features disclosed in claim 4 and claim 10 and claim 14, respectively. A reliable and efficient protection against abusive manipulations is thus realized.

Furthermore, for the solutions in accordance with the invention it has also been found that it is particularly advantageous to provide additionally the features disclosed in claim 5 and claim 11 and claim 15, respectively. This enables a permanent protection against abusive reading of a product code from the transponder.

The foregoing aspects and further aspects of the invention will become apparent from the embodiments described hereinafter and will be explained in detail with reference to these embodiments.

The invention will be described in detail hereinafter on the basis of an embodiment which is shown in the drawings, however, without the invention being restricted thereto.

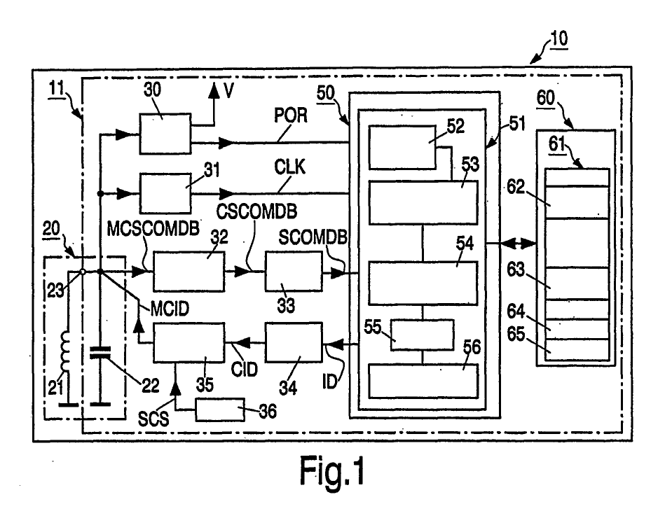

FIG. 1 is a diagrammatic representation in the form of a block diagram of an essential part, in the present context, of a transponder and an integrated circuit for this transponder in accordance with an embodiment of the invention.

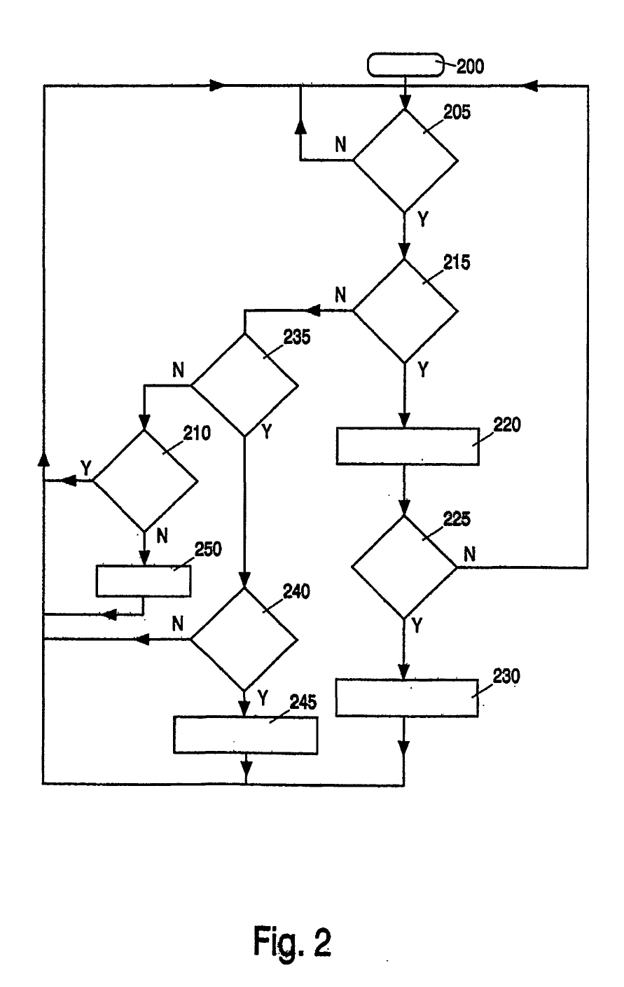

FIG. 2 shows a flow chart of a procedure taking place in the transponder, or in the integrated circuit for the transponder of FIG. 1, when a method in accordance with the invention is carried out.

FIG. 1 shows a transponder 10. The transponder 10 is constructed for wireless communication with a communication station (not shown). In the present case the transponder 10 is a transponder which is combined with a product and in which data concerning the product is stored, for example, data concerning the type of product, the sales price, the date of manufacture, the country of manufacture, expiry date and similar characteristics, as well as a serial number which is specific of, and hence significant for, the transponder 10, that is, a characteristic identification data block. The stored data form a product code which is significant for a product and may be in conformity with, for example, the so-called EPC (Electronic Product Code) or the so-called EAN code. The EPC code concerns a data word which consists of a total number of 96 (ninety-six) bits whereby each and every product in the world can be characterized in a significant and distinguishable manner. The transponder 10, however, may also be intended and constructed for other types of application.

The transponder 10 includes an integrated circuit 11. The transponder 10 also includes transfer means 20 which are operative in an inductive manner. Transfer means which operate on a capacitive, electromagnetic or optical basis may also be provided. The transfer means 20 consist of a transfer coil 21 which is provided outside the integrated circuit 11, and of a capacitor 22 which is realized within the integrated circuit 11. The transfer coil 21 is connected to a terminal 23 of the integrated circuit 11. The transfer coil 21 and the capacitor 22 form a resonant circuit whose resonance frequency corresponds to an actual frequency of at least one signal to be transferred from the communication station to the transponder 10. In the present case a signal to be transferred to the transponder 10 is an amplitude-modulated carrier signal, for example, a modulated, encoded safety command data block MCSCOMDB. Another type of transfer signal, however, is also feasible.

The transfer means 20, forming transmission means as well as receiving means, are arranged and constructed to receive the amplitude-modulated and coded safety command data block MCSCOMDB which contains a safety command data block SCOMDB. The amplitude-modulated and coded safety command data block MCSCOMDB can be generated by the communication system and can be transferred to the transponder 10 in a wireless manner by means of a field which is produced by the communication station and acts on the transponder 10. In the present case the transfer takes place in an inductive manner. The transfer, however, may also be carried out electromagnetically, the transfer means then being constructed as an electrical dipole.

The transponder 10, or the integrated circuit 11, contains a power supply circuit 30 and a clock signal regenerating stage 31 and a demodulation stage 32 which are all connected to the terminal 23, so that each of these elements is supplied with the signal received by the transponder 10.

The power supply circuit 30 is arranged and constructed to generate a DC supply voltage V on the basis of the signal applied thereto; this aspect is well known to those skilled in the art. The power supply circuit 30 is also arranged and constructed to generate a so-called “power on reset” signal POR which is generated whenever the transponder 10 has received an adequate amount of energy so that a sufficiently high DC supply voltage V is generated by means of the power supply circuit 30.

The clock signal regenerating stage 31 is arranged and constructed to regenerate a clock signal CLK while utilizing the signal applied thereto. This is a step which is also known to those skilled in the art. Instead of such a clock signal regenerating stage, a separate clock signal generator may be provided; this is advantageous notably when the wireless communication takes place at very high frequencies in the UHF range or in the microwave range.

The demodulation stage 32 is arranged and constructed to demodulate the amplitude-modulated coded safety command data block MCSCOMDB. When such an amplitude-modulated coded safety command data block MCSCOMDB is applied to the demodulation stage 32, a demodulated coded safety command data block CSCOMDB is produced in and output by the demodulation stage 32.

The demodulation stage 32 is succeeded by a decoding stage 33 which can be supplied with the coded safety command data block CSCOMDB and by means of which said coded data block is decoded. After successful decoding, the decoding stage 33 outputs the safety command data block SCOMDB.

The means described thus far become active in a receiving mode of the transponder 10. In addition to such a receiving mode, the transponder is suitable for a transmission mode, or a transfer mode, from the transponder 10 to the communication station. To this end, the transponder 10, or the integrated circuit 11, includes a coding stage 34 and a modulation stage 35, succeeding the coding stage 34, and an auxiliary carrier signal generator 36 which is connected to the modulation stage 35. The output of the modulation stage 35 is connected to the terminal 23 and hence to the transfer means 20 which in this case constitute transmission means. The coding stage 34 can be supplied with various signals such as inter alia identification data ID whose origin will be described in detail hereinafter. The coding stage 34 is capable of coding the identification data ID, the coding stage 34 outputting coded identification data CID after successful encoding. The coded identification data CID can be applied to the modulation stage 35. An auxiliary carrier signal SCS, generated by means of the auxiliary carrier signal generator 36, can also be applied to the modulation stage 35. Utilizing the coded identification data CID, the modulation stage 35 performs amplitude modulation of the auxiliary carrier signal SCS so that the modulation stage 35 supplies the transfer means 20 with identification data MCID which have been modulated in respect of amplitude and have also been coded further, said transfer means 20 then providing a transfer to the communication station. Phase modulation or frequency modulation may also be carried out instead of amplitude modulation.

The transponder 10, or the integrated circuit 11 of the transponder 10, includes a microcomputer 50. Instead of the microcomputer 50, a hard-wired logic circuit may be provided. The microcomputer 50 can be supplied with the power on reset signal POR and the clock signal CLK as well as with the safety command data block SCOMDB. The microcomputer 50 is also constructed to output the identification data ID.

Storage means 60, which include a RAM and a ROM or an EEPROM and are well known to those skilled in the art, co-operate with the microcomputer 50. The storage means 60 include an addressable memory 61 which comprises a plurality of memory sections, that is, a memory section 62 for storing first safety state information, a memory section 63 for storing second safety state information, a storage section 64 for storing product identification information, and a memory section 65 for storing encryption result information.

The microcomputer 50 also includes sequence control means 51 by means of which a plurality of sequences, notably program routines, can be controlled. The following means are realized by means of the microcomputer 50 so as to be controlled by means of the sequence control means 51: command recognition means 52, first state changing means 53, second state changing means 54, inhibit means 55 and command data block processing means 56.

FIG. 2 shows a flow chart of a routine, that is, of a method which is carried out by means of the microcomputer 50 and the sequence control means 51. The execution of the method should be considered in the general context of handling of the transponder 10. The transponder 10 is combined with a product and has an unambiguous identification code of the product in the present case, that is, a so-called electronic product code (EPC) which is stored in the memory section 64 provided for this purpose. The EPC serves to enable backtracking, that is, securing its originality, of the product and can be read by means of a communication station for communication with the transponder 10. In addition to the EPC, an encryption result is stored in the memory section 65 of the transponder 10, or the integrated circuit 11, which is provided for this purpose, said encryption result being obtained by means of a symmetrical encryption method in conformity with the so-called Data Encryption Standard (DES) performed on the EPC with a key. It is to be noted that such encryption can also be performed by means of another method, for example, in conformity with the so-called Advanced Encryption Standard (AES).

A product as stated above, being a pair of sports shoes in the present case, is present in a sales outlet or in a store, constituting a first product location area, so that it can be purchased by a customer. When this product is purchased or acquired by the customer, the product is taken to a sales terminal of the store. The sales terminal defines a safety state activation zone. The sales terminal includes a sales communication station for communication with the transponder 10, said sales communication station having a given communication range which defines the dimensions of the safety state activation zone. Subsequently, the purchased product is moved past the sales terminal so that it is transferred from the first product location area, formed by the store, via the safety state activation zone comprising the communication station of the sales station, to a second product location area which comprises the area of the store which is situated behind the sales terminal, but also all further areas whereto the purchased product could be taken by the buyer, so also the home of the buyer. The sales communication station and the transponder 10 of the product purchased by the buyer perform a communication operation during the passage by the sales terminal, so that the above routine in conformity with FIG. 2 is carried out.

Starting at a block 200, subsequently in a block 205 it is checked, using the command recognition means 52, whether a command data block has been received; this reception has been explained in the above description of the receiving mode.

If such a command data block has been received, the command data block received is applied to the first state changing means 53 in which the routine continues in a block 215. Otherwise, in the block 205 the reception of a command data block is checked again.

In the block 215 it is checked whether the command data block concerns a safety preparation command data block. If this is the case, the procedure continues in a block 220, and otherwise the command data block is applied to the second state changing means 54 in which the procedure is continued in a block 235.

In the block 220 the EPC is transferred to the sales communication station and subsequently the procedure is continued in a block 225. In the sales communication station the EPC is encrypted with a key which has been communicated to the sales communication station in advance and has thus been given a safety authorization. The acquisition of such a safety authorization or such a key is coupled to an authorization to sell the product. However, this procedure may also be set up in a different way.

It is to be noted that the transfer of the EPC need not necessarily take place in the block 220, but may also take place at another instant, for example, already before the transmission of a safety preparation command data block.

During the encryption carried out in the sales communication station, a comparison encryption result is obtained and applied to the transponder 10. In the block 225 the comparison encryption result is compared with the encryption result stored in the memory section 65. If the two encryption results correspond, the procedure continues in a block 230 and otherwise it is started anew in the block 205. It is to be noted that the procedure may also be interrupted in the case of non-corresponding encryption results or that a different procedure may be carried out. For example, it may be arranged that the transmission of the safety preparation command data blocks can be repeated only after a given period of time has elapsed and/or that only a given number of repeated transmissions of the safety preparation command data blocks is possible.

In the block 230 a bit of the memory section 62 for storing a first safety state information is set to logic “1” (TRUE) and hence the transponder is set from an initial state to a first safety state. Subsequently, the procedure is continued in the block 205. It is to be noted that the first safety state information may also be stored in the memory section 62 in the form of a plurality of bits.

The product and the transponder 10 which is connected thereto and is now in a first safety state, for example, are taken home subsequent to the purchase by the customer. In the present case the transponder 10 combined with the product will be present in a second product location area as from the instant at which the transponder 10 passes the sales terminal and hence is transferred through the safety state activation zone so as to be set to the first safety state; if desired, the product can be set to a second safety state by the customer. The setting to the second safety state is carried out by means of a home communication station which is provided for this purpose and is arranged to communicate with the transponder 10, a safety command data block SCOMDB then being applied to the transponder 10. In conformity with the procedure or method shown in FIG. 2 and described above, after the reception of the safety command data block SCOMDB in the block 205 the safety command data block SCOMDB is applied, via the block 215, to the second state changing means 54 and the procedure is continued in the block 235. In this case, because the safety command data block SCOMDB is concerned, from the block 235 the procedure is continued in a block 240. In the block 240 it is checked whether the bit of the memory section 62, provided for the first safety state information, has been set to logic 1 (TRUE). If this is the case, the procedure is continued in a block 245 and otherwise the procedure continues in the block 205. In the block 245 a bit of the memory section 63 for storing a second safety state information is set to logic “1” (TRUE) and, consequently, the transponder 10 is set to a second safety state and the procedure is continued in the block 205.

If the testing of a received command data block in the block 235 reveals that no safety command data block SCOMDB is concerned, the procedure continues in the block 210. In the block 210 it is checked in the inhibit means 55 whether the bit of the memory section 63 intended for the second safety state information has been set to logic 1 (TRUE). If this is not the case, the procedure is continued in a block 250 in which the received command data block is transferred to the command data block processing means 56. In the block 250 the received command data block is further processed by means of the command data block processing means 56, the procedure being continued in the block 205 after termination of the processing.

In the case of a positive decision in the block 210, the procedure is continued in the block 205. It is thus achieved that no command data block, notably no command data block for reading the EPC, is conducted to the command data block processing means 56, so that no received command data block can be processed therein, with the result that the transponder 10 no longer responds and is practically permanently deactivated.

It is to be noted that the inhibit means 55 may be arranged so as to deactivate the reception of command data blocks.

The transponder 10 in the described embodiment is set to the second safety state by a home communication station. It is to be noted that such setting to the second safety state can also be performed by means of the sales communication station.

A second embodiment in accordance with the invention relates to a transponder 10 which is non-detachably combined with a product, for example, with a cargo container for receiving and transporting cargo. In the present embodiment the cargo container is rented by a company A in order to forward goods from South America to Europe; the container is then situated in a first product location area. The transponder 10 which is combined with the cargo container then stores customer data in the form of cargo data and transport data, memory sections for storing the customer data being provided in the addressable memory 61 of the integrated circuit 11 of the transponder 10. In order to prevent abusive modification of the customer data, the customer data is permanently protected or “locked” against overwriting or modification. To this end, second safety state information which is stored in the memory section 63 co-operates with the inhibit means 55 and prevents such overwriting in that a bit of the memory section 63 which is provided for this purpose is set to logic “1” (TRUE).

For renewed use of the cargo container it is necessary to reset the permanent write protection of the customer data of the non-detachably attached transponder 10. Such resetting can be performed in a manner similar to that described above in conjunction with the description of the procedure of FIG. 2.

Instead of the sales location with the safety authorization, as in the first embodiment, in the case involving the cargo container a customs authority or another authorized institution acts as a safety state activation location which is capable of carrying out a test of the customer data and of carrying out a deactivation of the write protection in a safety state activation zone. Upon arrival in Europe the shipped cargo container is submitted to such a customs authority or is admitted by such a customs authority.

The deactivation of the write protection is carried out by means of the first state changing means 53; the already described part of the procedure of FIG. 2 is then carried out in the blocks 205, 215, 220, 225 and 230 and additionally in the block 230 the bit of the memory section 63 which is provided for the second safety state information is set to logic “0” (FALSE), corresponding to erasure. The transponder 10 of the cargo container is thus set to a first safety state. The cargo container released by the customs authorities is subsequently transported to its destination, being a European company B; this means that the container is moved to a second product location area. The company B in turn can then use the unloaded cargo container again for a further delivery of goods, because the transponder 10 which is non-detachably combined with the cargo container is again ready for the writing of customer data of the company B in the memory section provided for this purpose; it can protect this data against abusive modification by subsequently transmitting the safety command data block SCOMDB.

It is to be noted that the described procedure for the embodiment involving the cargo container can also be used for other products provided with a transponder which is non-detachably combined with the product, for example, for rental video cassettes or similar products where the rental data is stored in the transponder and subsequently protected against manipulation. Reactivation of the transponder in the case of reclamation or service or re-use can take place by setting the transponder to a first safety state in a rental outlet, such setting to the first safety state being carried out as described above for the method for influencing the transponder permanently combined with the cargo container. Subsequently, the rental data can be modified and protected against manupulation by setting to the second safety state.

1. A method of securing a transponder against undesirable manipulation, which transponder is combined with a product, contains a product code which is significant for the product, and is constructed for wireless communication with a communication station, in which method at least one change of state is carried out, the transponder being set, during a first step of the method involving a first state of change, from an initial state to a first safety state when the product undergoes a transfer from a first product location area to a second product location area, via a safety state activation zone which includes a communication station, and in which method, if the transponder has been set to the first safety state due to the transfer, the transponder is set to a second safety state, if desired, during a second step of the method in which a second change of state is carried out.

2. A method as claimed in claim 1, in which the changes of state are initiated by means of commands which are applied to the transponder by the communication station.

3. A method as claimed in claim 1, in which the first step of the method is carried out at a point of sales (POS) terminal which defines a secured environment.

4. A method as claimed in claim 1, in which an encryption procedure is carried out during the first step of the method.

5. A method as claimed in claim 1, in which the transponder is set to a second safety state in which the transponder is permanently deactivated.

6. A method as claimed in claim 1, in which, upon execution of the first change of state whereby the transponder is set to a first safety state, a write protection for memory sections of the transponder is deactivated and in which the transponder, if desired, is set from the first safety state to a second safety state in which the write protection for memory sections of the transponder is activated. Preliminary Amendment

7. A method as claimed in claim 4, in which the transponder is set, if desired, from the second safety state to a further safety state.

8. A transponder which is intended to be combined with a product, is constructed for wireless communication with a communication station, includes storage means for storing a product code which is significant for the product, is constructed for carrying out at least one state of change, and includes first state changing means by means of which the transponder can be set from an initial state to a first safety state if the product with which the transponder is combined is transferred from a first product location area to a second product location area, via a safety state activation zone which includes a communication station, and also includes second state changing means by means of which the transponder can be set to a second safety state if the transponder has been set to the first safety state.

9. A transponder as claimed in claim 8, in which command receiving means are provided so as to receive commands for carrying out the changes of state.

10. A transponder as claimed in claim 8, in which encryption result storage means are provided which are constructed for the storage of an encryption result which can be generated by means of an encryption procedure which can be carried out by the communication station.

11. A transponder as claimed in claim 8, in which inhibit means are provided for the permanent deactivation of the transponder.

12. An integrated circuit for a transponder which is intended to be combined with a product and is constructed for wireless communication with a communication station, which integrated circuit includes storage means for storing a product code which is significant for the product and for carrying out at least one change of state, and includes first state changing means by means of which the integrated circuit can be set from an initial state to a first safety state if the product with which the transponder is combined is transferred from a first product location area to a second product location area, via a safety state activation zone which comprises a communication station, and also includes second state changing means by means of which the integrated circuit can be set to a second safety state if the integrated circuit has been set to the first safety state.

13. An integrated circuit as claimed in claim 12, in which command receiving means are provided so as to receive commands for carrying out the changes of state.

14. An integrated circuit as claimed in claim 12, in which encryption result storage means are provided which are constructed for the storage of an encryption result which can be generated by means of an encryption procedure which can be carried out by the communication station.

15. An integrated circuit as claimed in claim 12, in which inhibit means are provided for the permanent deactivation of the integrated circuit.
